(19) United States
(12) Patent Application Publication
(10) Pub. No.: US 2025/0315660 A1
(43) Pub. Date: Oct. 9, 2025

(54) SYSTEM AND METHOD FOR ADAPTING GENERATIVE MODEL INPUT

(71) Applicant: TOYOTA RESEARCH INSTITUTE, INC., Los Altos, CA (US)

(72) Inventors: Kalani MURAKAMI, Cupertino, CA (US); Scott CARTER, San Jose, CA (US); Monica PhuongThao VAN, San Leandro, CA (US); Brandon HUYNH, Los Angeles, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/626,660

(22) Filed: Apr. 4, 2024

(51) Int. Cl. G06N 3/0475

(52) U.S. Cl. CPC G06N 3/0475

(57) ABSTRACT

A method for modifying an input for a group of generative models includes receiving the input for generating a group of outputs via the group of generative models. The method also includes modifying the input for each generative model of the group of generative models, the input being modified based on a respective specification of each generative model of the group of generative models. The method further includes generating, via each generative model of the group of generative models, the group of outputs based on modifying the input, each generative model generating a respective output of the group of outputs.

### FIELD

Aspects of the present disclosure generally relate to generative models, and more specifically to systems and methods for adapting generative model input.

### BACKGROUND

Generative models, such as generative artificial intelligence (AI) models, exemplify the capabilities of AI models trained on extensive datasets of pre-existing content (hereinafter referred to as “training data”). Based on this training, generative models may discern intricate patterns and establish meaningful connections within the training data and/or input data. When provided with a prompt, a generative model may create content in the form of text, images, and/or music in accordance with the training data and/or previous input data.

Generative model input specifications may vary based on their intended tasks and architectures. For instance, in most cases, natural language processing models receive textual inputs in the form of sentences or paragraphs. Image-based generative models implementing convolutional neural networks (CNNs) may receive image data structured in specific formats, such as arrays or tensors. For tabular data analysis, models such as Random Forest or Gradient Boosting Machines demand structured datasets with well-defined columns and rows. Similarly, recommendation systems might rely on user-item interaction matrices. Moreover, the preprocessing steps for data might differ based on the model's needs. That is, there may be diverse input requisites for various generative models.

### SUMMARY

In one aspect of the present disclosure, a method for modifying an input for a group of generative models includes receiving the input for generating a group of outputs via the group of generative models. The method also includes modifying the input for each generative model of the group of generative models, the input being modified based on a respective specification of each generative model of the group of generative models. The method further includes generating, via each generative model of the group of generative models, the group of outputs based on modifying the input, each generative model generating a respective output of the group of outputs.

Another aspect of the present disclosure is directed to an apparatus including means for receiving the input for generating a group of outputs via the group of generative models. The apparatus also includes means for modifying the input for each generative model of the group of generative models, the input being modified based on a respective specification of each generative model of the group of generative models. The apparatus further includes means for generating, via each generative model of the group of generative models, the group of outputs based on modifying the input, each generative model generating a respective output of the group of outputs.

In another aspect of the present disclosure, a non-transitory computer-readable medium with non-transitory program code recorded thereon is disclosed. The program code is executed by one or more processors and includes program code to receive the input for generating a group of outputs via the group of generative models. The program code also includes program code to modify the input for each generative model of the group of generative models, the input being modified based on a respective specification of each generative model of the group of generative models. The program code further includes program code to generate, via each generative model of the group of generative models, the group of outputs based on modifying the input, each generative model generating a respective output of the group of outputs.

Another aspect of the present disclosure includes an apparatus including one or more processors, and one or more memories coupled with the one or more processors and storing instructions operable, when executed by the one or more processors, to cause the apparatus to receive the input for generating a group of outputs via the group of generative models. Execution of the instructions further cause the apparatus to modify the input for each generative model of the group of generative models, the input being modified based on a respective specification of each generative model of the group of generative models. Execution of the instructions also cause the apparatus to generate, via each generative model of the group of generative models, the group of outputs based on modifying the input, each generative model generating a respective output of the group of outputs.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram illustrating an example of a system generating content via a generative model, in accordance with various aspects of the present disclosure.

FIG. 2 is a diagram illustrating an example of a hardware implementation for a system, in accordance with various aspects of the present disclosure.

FIG. 3 is a flow diagram illustrating a pipeline for using multiple generative models, in accordance with various aspects of the present disclosure.

FIG. 4 illustrates a region indication tool, in accordance with various aspects of the present disclosure.

FIGS. 5A and 5B illustrate an inpainting and rating tool, in accordance with various aspects of the present disclosure.

FIG. 6 is a flow diagram illustrating an example process for adapting an input for a group of generative models, in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

As discussed, generative artificial intelligence (AI) models are trained to discern patterns and establish meaningful connections within datasets of pre-existing content (hereinafter referred to as “training data”). Generative AI models may also be referred to as generative models, hereinafter used interchangeably. Based on this training, generative models may discern intricate patterns and establish connections within the input data. When provided with a prompt, a generative model may create content in various forms, such as, but not limited to, text, images, and/or music in accordance with the training and/or previous input data.

Recent technical innovations in generative models have increased development in generative models that can create new, complex images from simple text prompts. Such generative models may generate images, videos, animations, and/or three-dimensional objects from text and image-based prompts. In some cases, generative models follow a text-to-image paradigm, in which users supply a text prompt that the system uses to generate an image. In some other cases, generative models may receive as an input both an image and text (which serve to ground the resulting output). Additionally, or alternatively, generative models may integrate region or mask information to inpaint certain regions of a supplied image. Additionally, or alternatively, generative models may combine text, region, and image prompts to adjust the resulting generating media (e.g., the output of the generative model).

Generative models can also vary in their specifications and capabilities. For example, some generative models may specify that text prompts should have a particular length and/or images should have a minimum and/or maximum resolution. Of course, other specifications may be associated with a generative model, for example, input and output images may be specified to have a square shape. The variety of input specifications and output targets presents a number of challenges for designers seeking to incorporate one or a number of image generation tools into their systems. Additionally, the variety of input specifications and output targets presents a challenge for research aiming to compare generative models against one another.

Also, while there are a number of generative models that generate media (e.g., images, audio, and/or video), each media generation model may have proprietary peculiarities. As such, media generation models may be tailored for specific use cases. Therefore, app designers looking to integrate models into larger systems may experiment with many different generative models to understand their relative strengths and weaknesses. This experimentation may be time consuming for app developers. Furthermore, because new generative models are consistently being made available, designers may need to evaluate generative models on a regular basis.

Conventional AI-based systems for generating media, offer access to a wide variety of third-party and open-source foundation models (e.g., generative models). The systems may include some inpainting models as well as AI-based image upscalers. However, conventional systems have several drawbacks. First, while conventional systems may support a large assortment of generative models, there are no features to integrate a diverse set of generative models. In some cases, these conventional systems may target enterprise use cases. Therefore, extensive vetting of generative models is a critical feature, but the vetting process may hinder experimentation. In most cases, conventional systems do not include features specifically designed to compare the usefulness of different generative models for a given use case.

Another drawback of conventional systems is the lack of flexibility of individual generative models. For example, one use case for generative AI has been to help people redesign environments. However, individual generative models may only be suited to a small subset of the overall task. For instance, one generative model may only be capable of interior redesign functionality, while another generative model can only redesign exterior spaces. Therefore, for an environmental redesign task, a user may be forced to implement the two generative models individually. To individually implement the generative models, the user often must spend a great deal of time tailoring a respective input and output for each generative model. Therefore, in may be desirable to provide a system for implementing multiple generative models.

Various aspects of the present disclosure are directed to techniques for implementing multiple generative models by adapting an input and/or output associated with a group of generative models. In some examples, a system receives one or more inputs for processing by the group of generative models. Each generative model, of the group of generative models, may have particular input specifications. The system may modify the one or more inputs based on the respective specifications of the generative models. For instance, the system may resize an image and expand a text prompt such that the image and prompt conform to input specifications of one of the generative models.

After the system modifies the one or more inputs, each generative model in the group of generative models generates an output based on the modified inputs. Naturally, each generative model may generate a unique output. The system may alter each output. For example, if one generative model generates a three-dimensional shape as a first output and a second generative model generates a two-dimensional image as a second output, the system may inject the three-dimensional shape into the two-dimensional image so that a user can view both outputs using only an image viewer.

Particular aspects of the subject matter described in this disclosure can be implemented to realize one or more of the following potential advantages. In some examples, the described techniques and systems, such as a processing platform for evaluating different generative models may reduce an amount of time for a user to compare the different generative models.

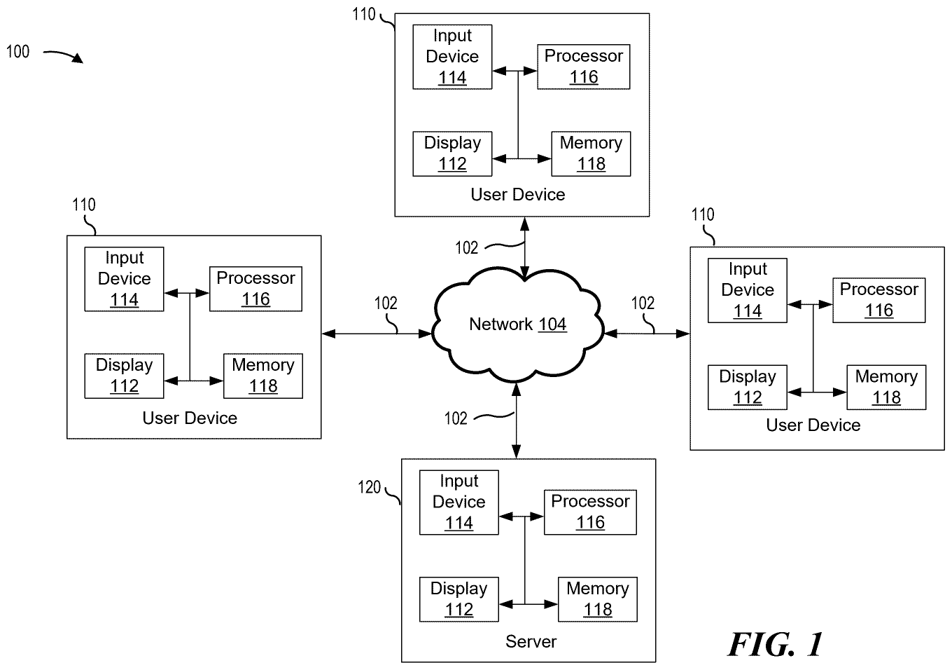

FIG. 1 is a block diagram illustrating an example of a system 100 generating content via a generative model, in accordance with aspects of the present disclosure. As shown in the example of FIG. 1, the system 100 may include one or more user devices 110 and one or more servers 120. For ease of explanation, only one server 120 is shown in the example of FIG. 1. Each user device 110 may be connected to a network 104 via one or more communication links 102. The communication links 102 may be wired and/or wireless communication links. The server 120 may also be connected to the network 104 via a communication link 102.

The network 104 may be an example of the Internet. Additionally, or alternatively, the network 104 may include any suitable computer network such as an intranet, a wide-area network (WAN), a local-area network (LAN), a wireless network, a digital subscriber line (DSL) network, a frame relay network, an asynchronous transfer mode (ATM) network, and/or a virtual private network (VPN). The communication links 102 may be any type of communication link that may be suitable for communicating data between user devices 110 and the server 120. For example, the communication links 102 may network links, dial-up links, wireless links (e.g., Wi-Fi link, satellite link, or cellular communication link), and/or hard-wired links.

The server 120 may be a computing device, such as a server, processor, computer, cloud computing device, cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to host a generative model and communicate via a wireless or wired medium. In some examples, the server 120 may host a generative model. In some such examples, one or more server 120 may work in tandem to host the generative model. Specifically, the server 120 may implement functions and/or computer code that runs the generative model and/or a site, such as a website, for accessing the generative model.

Each user device 110 may be an example of a personal computing device, a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium. A user device 110 may be used by a user to input a prompt to a generative model via an interface associated with the generative model. The interface may be accessed via a website or a dedicate application, such as a mobile phone application. Additionally, or alternatively, the user device 110 may store the generative model, and the user may input a prompt via an interface associated with the stored generative model. In some examples, each user device 110 shown in FIG. 1 may be used by a different user. Each user device 110 and server 120 may be stationary or mobile.

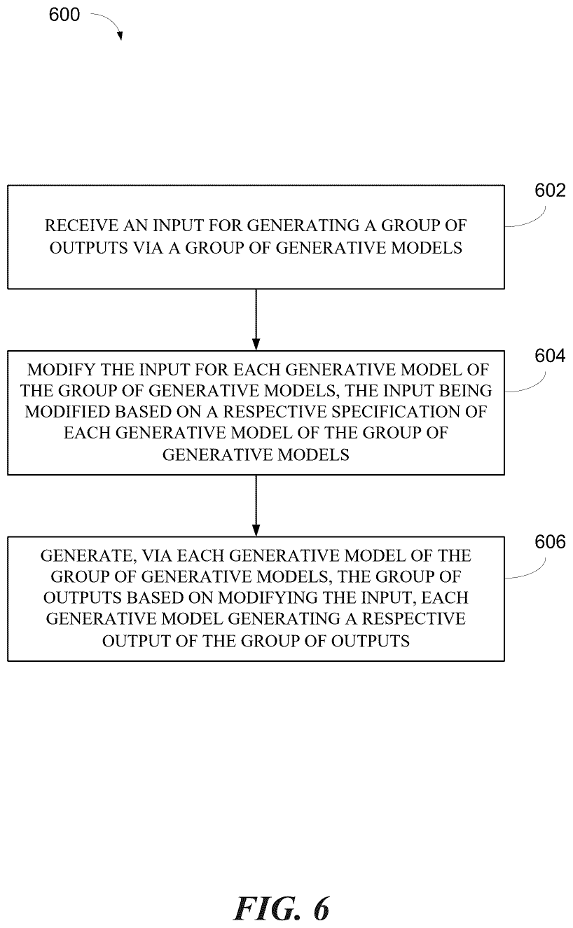

In some examples, each user device 110 may be included inside a housing that houses components of the user device 110, such as one or more processors 116 and a memory 118. The housing may also include, or be connected to, a display 112 and an input device 114, which may be interconnected with other components of the user device 110. For ease of explanation, only one processor 116 is shown for each user device 110. In some examples, the one or more processors 116, the display 112, the input device 114, and the memory 118 may be interconnected via a bus architecture. The memory 118 may include one or more different types of memory, such as random access memory (RAM), static RAM (SRAM), dynamic RAM (DRAM), and/or another type of memory. Each user device 110 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the user device 110. The input device 114 may be used to navigate the interface associated with the generative model, provide input to an input modification module, and/or perform other tasks. Working in conjunction with one or more components of the user device 110, the processor 116 may receive information associated with the generative model, and control the display 112 to output information associated with the generative model. The display 112 may output (e.g., display) information received at the processor 116. In some examples, the processor 116 of the user device 110 is configured to perform operations and implement one or more elements associated with one or more processes, such as the process 600 described with respect to FIG. 6.

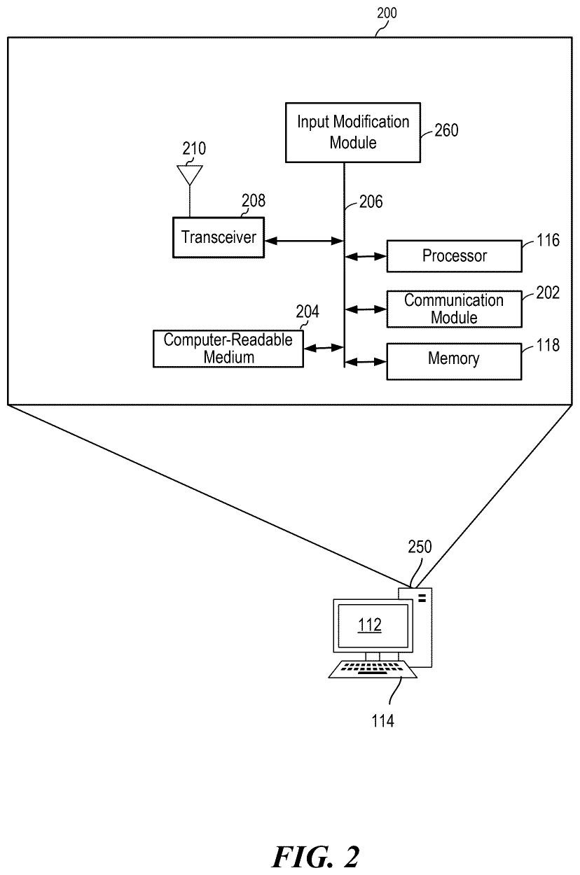

In some examples, a generative AI host may maintain the server 120. The server 120 may be included inside a housing that houses components of the server 120, such as one or more processors 116 and a memory 118. The housing may also include, or be connected to, a display 112 and an input device 114, which may be interconnected with other components of the user device 110. For ease of explanation, only one processor 116 is shown for the server 120. In some examples, the one or more processors 116, the display 112, the input device 114, and the memory 118 may be interconnected via a bus architecture. The memory 118 may include one or more different types of memory, such as RAM, SRAM, DRAM, and/or another type of memory. The server 120 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the server 120. For example, the processor 116 may execute instructions for maintaining the generative model, training the generative model, and/or executing the generative model. In some examples, the processor 116 of the server 120 is configured to perform operations and implement one or more elements associated with one or more processes, such as the process 600 described with respect to FIG. 6. Additionally, or alternatively, the processor 116 of the server 120 may be configured to perform operations associated with the input modification module 260 described with reference to FIG. 2.

FIG. 2 is a diagram illustrating an example of a hardware implementation for a system 200, according to various aspects of the present disclosure. The system 200 may be a component of a device 250. The device 250 may be an example of a user device 110 or a server 120 described with reference to FIG. 1. As shown in the example of FIG. 2, the device 250 may include a display 112 and an input device 114 (e.g., a keyboard). In some examples, the system 200 is configured to perform operations and implement one or more elements associated with one or more processes, such as the process 600 described with reference to FIG. 6.

The system 200 may be implemented with a bus architecture, represented generally by a bus 206. The bus 206 may include any number of interconnecting buses and bridges depending on the specific application of the system 200 and the overall design constraints. The bus 206 links together various circuits including one or more processors and/or hardware modules, represented by a processor 116, and a communication module 202. The bus 206 may also link various other circuits such as timing sources, peripherals, voltage regulators, and power management circuits, which are well known in the art, and therefore, will not be described any further.

The system 200 includes a transceiver 208 coupled to the processor 116, the communication module 202, and the computer-readable medium 204. The transceiver 208 is coupled to an antenna 210. The transceiver 208 communicates with various other devices over a transmission medium, such as a communication link 102 described with reference to FIG. 1. For example, the transceiver 208 may receive commands via transmissions from a user or a remote device.

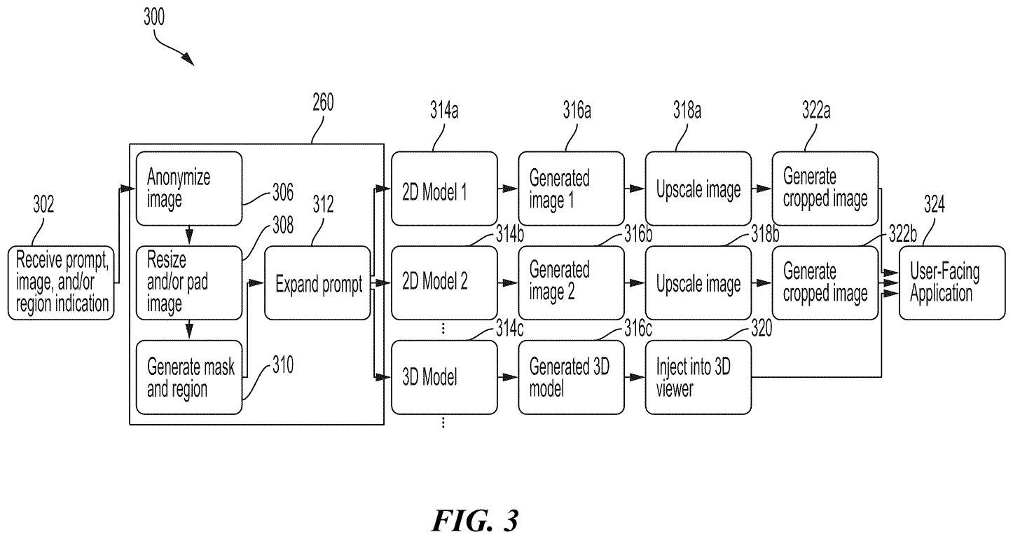

As shown in the example of FIG. 2, the system 200 may include an input modification module 260 that may be trained to perform one or more tasks associated with adapting generative model input and output. For example, the input modification module 260 may be configured to perform the tasks described with reference to the one or more modules and engines described with reference to FIG. 3. The input modification module 260 may include artificial or computational intelligence elements, such as, neural network, fuzzy logic, or other machine learning algorithms. In one or more arrangements, one or more of the other modules 116, 118, 202, 204, 208, can also include artificial or computational intelligence elements, such as, neural network, fuzzy logic, or other machine learning algorithms. Further, in one or more arrangements, one or more of the modules 116, 118, 202, 204, 208 can be distributed among multiple modules 116, 118, 202, 204, 208, 260 described herein. In one or more arrangements, two or more of the modules 116, 118, 202, 204, 208, 260 of the system 200 can be combined into a single module.

The system 200 includes the processor 116 coupled to the computer-readable medium 204. The processor 116 performs processing, including the execution of software stored on the computer-readable medium 204 providing functionality according to the disclosure. The software, when executed by the processor 116, causes the system 200 to perform the various functions described for a particular device, such as any of the modules 116, 118, 202, 204, 208, 260. For example, when executed by the processor 116, the software causes the system 200 and/or the input modification module 260 to implement one or more elements associated with one or more processes, such as the process 600 described with respect to FIG. 6. The computer-readable medium 204 may also be used for storing data that is manipulated by the processor 116 when executing the software. For example, working in conjunction with one or more of the other modules the modules 116, 118, 202, 204, and 208, the input modification module 260 may perform one or more operations, such as one or more operations of the process 600 described with reference to FIG. 6.

As indicated above, FIGS. 1 and 2 are provided as examples. Other examples may differ from what is described with regard to FIGS. 1 and 2.

As discussed, various aspects of the present disclosure are directed to a platform for implementing multiple generative models by modifying one or more inputs and/or outputs. For example, a user, such as a community member, may wish to redesign an environment within the user's community. The user may upload, to the platform, photos of areas within their community that they would like to see improved, along with narratives describing the content of the photo and the potential impact of the improvement. The platform may then guide other community members through sequences of narratives and photos. Users may then be asked to modify one of their own photos to accommodate the perspective of another community member's needs based on the community members' uploads.

This use case, where a member of a community redesigns an environment using generative models, is well-suited to generative models because, unlike systems supporting designers, most users are likely to be design novices. The users do not have the artistic or technical expertise to, by themselves, redesign environments. However, most users do have access to and familiarity with mobile and web applications. Therefore, the users already have the expertise to interact with generative models via an application provided by the platform. After receiving input from the users, the generative models may then redesign an environment based on the users' input.

The platform may leverage generative inpainting models to modify an image of an environment. In contrast to text-to-image generative models that generate an output from a user-supplied text prompt, generative inpainting models may receive, as an input, one or more of an initial image, a region within the initial image, or a user-supplied prompt describing how the generative model should modify the region. Some generative inpainting models may also receive an additional grounding media (e.g., image), as an input, to provide further guidance to the generative model.

Generative models have the potential to lower the barriers to entry to multimedia design, which may improve communication between people. Although advances in generative models are rapid, it is less clear how well this new paradigm functions in the context of specific scenarios. To ground user needs in a realistic task, various aspects of the present disclosure bring generative models to bear. In some examples, the task may specify deployment of particular types of generative models that allow users to modify pre-existing media, in which users supply an image and a text prompt that instructs a generative model on how to modify the image.

Many generative models have strict input and output image size specifications. For instance, some generative models work only with 512×512 pixel images, while others work with any image that is square, or with images that are divisible by some factor of two, etc. Furthermore, the process for implementing generative models is not standardized. For example, some generative models use a binary image mask to inpaint media into an image (e.g., black or white images with the reverse color indicating the region to be inpainted). Other generative inpainting models use transparency, while other generative models use an integer array representing a bounding box. The wide variety of generative model specifications makes it difficult for users to use any one generative model, much less compare the results of several at once.

Various aspects of the present disclosure abstract away the eccentricities of generative model specifications such that a user may leverage multiple generative models. By leveraging multiple generative models, the user may compare and contrast the way different generative models may work for a specific use case. Some examples are directed to a processing platform that allows the user to evaluate different generative models in the context of multiple use cases. For example, a user may implement the platform to generate a set of outputs using a group of different generative models. The user may then select an output based on the user's preferences.

FIG. 3 is a flow diagram illustrating a pipeline for using multiple generative models, in accordance with aspects of the present disclosure. Various devices may implement the pipeline 300, such as the system 100 discussed with respect to FIG. 1, or the input modification module 260 discussed with respect to FIG. 2. As illustrated in FIG. 3, the pipeline 300 is divided into separate modules, each module being separately configurable to allow a single set of user inputs to leverage a variety of generative models.

The pipeline 300 may receive an input 302 that includes a prompt, image, and/or region indication (e.g., sketched region). In some examples, a user may interact with an interface to provide the input 302. The text prompt may indicate a desired modification to the image or to the sketched region of the image. The sketched region may indicate a portion of the image that the user wishes to modify. The user may provide the sketched region via a sketching tool integrated with the interface.

The pipeline 300 may additionally include the input modification module 260 discussed with respect to FIG. 2. The input modification module 260 may include hardware configured to anonymize an image, resize and pad an image, generate a mask and region for an image, and/or expand a text prompt. In some examples, the input modification module 260 may utilize machine learning techniques to perform one or more tasks. For example, the input modification module 260 may implement conventional object segmentation techniques to determine a region of the input image based on the user's prompt.

The input modification module 260 may include an anonymizing module 306 that anonymizes images in the input 302. Anonymizing the image may include altering or obscuring identifiable details within the visual content of the image to ensure the anonymity and privacy of individuals or sensitive information portrayed by the image, while maintaining the overall visual context or relevance of the image. The input modification module 260 may implement one or more conventional techniques such as blurring or pixelating faces, license plates, or other identifiable features within the image. The anonymizing module 306 may additionally or alternatively implement an image anonymization service to anonymize the image. The image anonymization service may be compliant with one or more privacy laws, such as the general data protection regulation (GDPR). Additionally, the anonymizing module 306 may remove metadata or geolocation tags embedded in the image file to help prevent the tracing of the image back to its source or original location. By removing sensitive information, anonymization may enable a user to implement the pipeline 300 while maintaining privacy guarantees.

The input modification module 260 also includes a resizing module 308 that may resize and/or pad the image. The resizing module 308 may adjust the size and shape of the image such that the image conforms to the input specification of one or more generative models. For example, the resizing module 308 may resize the image to a 512×512 pixel format because many generative models input images in a 512×512 pixel format.

To resize the image, the resizing module 308 may alter dimensions of the image by reducing or enlarging the image's overall size or by adjusting a number of pixels in the image. Techniques for decreasing image size may include downsampling, compression, cropping, and/or adjusting resolution or dimensions. Downsampling reduces as size of the image by discarding pixel information, often by averaging or selecting a subset of pixels. The image may be enlarged by increasing the image size or dimensions. To enlarge an image, the resizing module 308 may use interpolation techniques to estimate and insert new pixels. This resizing process may be specified to fit an image into specific dimensions such that the image conforms to one or more input specifications of a generative model.

To pad the image, the resizing module 308 may add additional pixels around the borders of the image, extending the image's dimensions. Padding maintains spatial information and prevents information loss, particularly when applying certain operations such as convolution or resizing. The resizing module 308 may implement various techniques to pad the image, such as reflecting image edges to create a mirror effect, ensuring consistent information representation across the image's borders.

The pipeline 300 may also include a mask module 310 for generating an image mask and region. The image mask and region may be a binary or grayscale image used to highlight specific regions or elements within an image by isolating or revealing particular areas of interest. The mask module 310 may generate the mask image and region based on the prompt, image, and/or region indication received in the input 302. For example, the mask module 310 may generate a binarized image indicating pixels to be inpainted based on the prompt, image, and/or region indication. The mask module 310 may create different types of masks used by one or more generative models, such as image-based binary masks, image-based masks that leverage transparent pixels, and bounding box regions.

The pipeline 300 may include a prompt module 312 for expanding prompts received in the input 302. In some examples, expanding the prompt may include elaborating or adding details to the prompt, enabling generative models to generate more comprehensive, nuanced, or contextually rich outputs based on the expanded prompt. For example, the pipeline 300 may implement a large language model (LLM) to expand the prompt.

After the input modification module 260 modifies the input 302, the resulting data may then be used by the pipeline 300 as input for one or more generative models. The generative models may have differing input specifications. In the example illustrated in FIG. 3, the pipeline 300 includes a first generative model 314a, second generative model 314b, and a third generative model 314c. The first generative model 314a and second generative model 314b may specify a two-dimensional image as input, while the third generative model 314c may specify a three-dimensional model as input. In this example, the pipeline 300 may implement various aspects of the present disclosure to process the received prompt, image, and/or region indication to generate an output from the input modification module 260. In some examples, the different input specifications may be known to the input modification module 260. In such examples, the input modification module 260 autonomously generates multiple inputs, in which each one of the multiple inputs conforms to a different input specification. In some such examples, the input modification module 260 may communicate with each generative model to understand the respective input specifications. The communication may be via an application programming interface (API) or another communication interface.

The output of the input modification module 260 may conform to respective input specifications for the various generative models, including one or more dimensionality specifications. Additionally, the output of the input modification module 260, which includes one or more of a modified prompt, image, or region indication, may be used as input for one or more of the first generative model 314a, second generative model 314b, and/or third generative model 314c. For example, the pipeline 300 may forward a modified image, mask region, and modified text to the first generative model 314a and second generative model 314b. In some examples, an unmodified prompt may be input to the third generative model 314c because the third generative model 314c may have different input specifications than the other two generative models.

After receiving respective inputs, the three generative models 314a, 314b, and 314c may each produce an output. The first generative model 314a may produce a first generated image 316a, the second generative model 314b may produce a second generated image 316b, and the third generative model 314c may produce a generated three-dimensional model 316c. The pipeline 300 may include a first upscaling module 318a for upscaling the first generated image 316a. The pipeline 300 may also include a second upscaling module 318b for upscaling the second generated image 316b. For example, the first upscaling module 318a and the second upscaling module 318b may implement an AI-based image upscaling technique to change the generated image's dimensions to match the dimensions of the image received in the input 302. The first upscaling module 318a or the second upscaling module 318b may additionally or alternatively remove padding from the generated image.

While the first generative model 314a and second generative model 314b may generate two-dimensional images as output, the third generative model 314c may produce a generated three-dimensional model 316c as output. As such, the pipeline 300 may implement three-dimensional processing functionality regarding the three-dimensional model. For example, the pipeline 300 may include an inpainting module (not shown in the example of FIG. 3) for three-dimensional generated content.

The inpainting module may use inpainting techniques to inpaint (e.g., add) a two-dimensional image or a three-dimensional model within a two-dimensional image. In some examples, a user provides a text prompt, uploads an image, and indicates a region of the image via an interface. The pipeline 300 may then generate a mask region and/or modify the text prompt. In some cases, if the generative model does not support inpainting, the pipeline 300 may forward only the text prompt to the generative model.

Once the generative model produces three-dimensional content, the pipeline 300 may further refine the mask region, original image, and/or three-dimensional content by placing the three-dimensional content into a layer bounded by the mask region and above the original image. The interface may then display the resulting content to the user. As a result, the three-dimensional content may appear to float over the indicated region. The user may then use the interface to examine the three-dimensional model from different perspectives.

The pipeline 300 may include an injection module 320 that injects the generated three-dimensional model into a three-dimensional viewer component integrated with the interface. For example, a user may view the generated three-dimensional model using a virtual reality (VR) headset to render and display the generated three-dimensional model. In some examples, the injection module 320 may implement three-dimensional inpainting techniques by injecting a three-dimensional model into a region of an image, such as an image received in the input 302. As discussed, a user may rotate the three-dimensional model with respect to the image, such that the user may configure the displayed angle of the three-dimensional model in the image.

The pipeline 300 may include a first cropping module 322a that generates a cropped image based on the upscaled image generated by the first upscaling module 318a. Similarly, the pipeline 300 may include a second cropping module 322b that generates a cropped image based on the upscaled image generated by the second upscaling module 318b. For example, the first cropping module 322a and second cropping module 322b may selectively remove portions of the generated images by changing the images' composition or dimensions. The first cropping module 322a and second cropping module 322b may additionally or alternatively crop the generated images based on an image mask. For example, the first cropping module 322a and second cropping module 322b may remove pixels of an image that are not located within the mask area.

The pipeline 300 may also include a user-facing application 324 for displaying generated media via a display component, such as an interface. As discussed, the user may use a VR headset to view a generated three-dimensional model. On mobile devices, a user may view three-dimensional models generated by the pipeline 300 using one or more native augmented reality (AR) applications. Additionally or alternatively, the user-facing application 324 may implement a graphical user interface (GUI), such as a web-based GUI, allowing the user to provide information to the pipeline 300 and view or edit media generated by the pipeline 300. The user-facing application 324 may incorporate any display device or sound device to convey media to the user.

The pipeline 300 may display generated media via a web-based application. In some examples, the application implements a web-view component. The web-view component may include a button. When selected, the button may implement a uniform resource locator (URL) to display a resource that can be visualized in a three-dimensional scene. For generated images, the resource may be based on a masked image. Upon receiving a URL linked to a generated image, the application may generate a three-dimensional shape, adding the generated image as a texture to the three-dimensional shape. For generated three-dimensional models, the URL may link to the generated three-dimensional model itself. The application may then place the generated three-dimensional model into a scene to be viewed by a user. The application may also allow the user to manipulate how the injected media appears in the scene. For example, the app may include controls for placement, rotation, and opacity of the three-dimensional model and/or scene.

To apply an image mask, the pipeline 300 may display images by generating a separate version of the image cropped to a bounding box circumscribing the masked region. All pixels within the image falling outside of the masked region may be made transparent. For example, portions of the image may be made less opaque, allowing objects or content within the image to be seen while partially revealing a superimposed mask. Additionally or alternatively, pixels within the image falling outside of the masked region may be modified or removed from the image entirely. The pipeline 300 may then inject the image into a three-dimensional scene as a texture on a geometric shape.

As discussed, what may begin as an input 302 (e.g., an image, a sketch, and/or a text prompt) may become a large number of inputs that leverage a group of generative models. For example, if the pipeline 300 implements four generative two-dimensional image models and one three-dimensional model, a single user upload may generate one call to an anonymizer, five calls to the generative models, and four calls to an upscaler, for ten requests. The pipeline 300 may implement a wide variety of generative models. For example, some generative models may be commercial products, others may be early-stage, experimental research tools.

Because the pipeline 300 may implement a wide variety and number of generative models, each generative model request may take a potentially unbounded amount of time and may fail for unknown reasons. Additionally, the pipeline 300 may implement third-party services to deploy one or more generative models. Requests may process in an asynchronous, scalable manner that separates each generative model. The pipeline 300 may monitor each request as data progresses through the pipeline, applying a configurable timeout to each stage and retrying failed requests up to a configurable number of attempts. The pipeline 300 may forward successfully generated outputs to the user-facing application 324, whereas the pipeline 300 may disregard unsuccessful generative models. Because the pipeline 300 may disregard unsuccessful generative models, only a subset of the requested generative models may produce outputs that are ultimately forwarded to the user-facing application 324.

Although the example illustrated with respect to FIG. 3 may incorporate a prompt, image, and/or region indication as an input 302, other varieties of input media are contemplated. In some examples, the pipeline 300 may receive a video file as an input 302. The pipeline may then apply one or more of the discussed techniques to the input video file, such as downsampling frames of the video, cropping the video to a mask, and forwarding the video file to one or more generative models. The generative models may produce one or more video files as an output, the individual videos potentially being upscaled, cropped, and/or displayed via an interface. Similarly, the pipeline 300 may receive an audio file as input. The pipeline 300 may anonymize the audio file by removing names or phrases, downsample the audio file, and forward the audio file to one or more generative models. The pipeline 300 may produce sound based on the resulting output via the user-facing application 324. Still, other media formats are contemplated as input, such as three-dimensional models.

The pipeline 300 may also incorporate varying amounts of input for the same media format. For example, the pipeline 300 may receive ten images, each image, or one or more images generated based on the images, used as input for one or more generative models. Similarly, the pipeline 300 may receive varying amounts of prompts and region indications. The pipeline 300 may then implement one or more of the prompts and/or region indications to generate output. It is additionally contemplated that input media formats need not match output media formats. For example, the pipeline 300 may receive a three-dimensional model as input and generate a video file based on the three-dimensional model.

In some examples, the pipeline 300 may request or receive input based on one or more input specifications of generative models implemented by the pipeline 300. For example, if the first generative model 314a is configured to input an image file in a portable network graphics (PNG) format, the pipeline 300 may solicit input in a PNG format. Similarly, the input modification module 260 may modify the input or generate new input based on one or more input specifications of generative models implemented by the pipeline 300. For example, if the pipeline 300 receives a PNG file in the input 302, but the second generative model 314b is configured to input files in a graphics interchange (GIF) format, the input modification module 260 may convert the PNG file to a GIF format.

As discussed, the input modification module 260 may perform one or more operations based on input specifications of one or more generative models, such as the generative models 314a, 314b, and 314c, implemented by the pipeline 300. For example, if a first generative model 314a is configured to receive a text prompt of a defined length of characters, the input modification module 260 may expand or truncate a received text prompt such that the text prompt conforms to input specifications of the first generative model 314a. The input modification module 260 may similarly anonymize, downsample, pad, mask, or otherwise modify the input 302 based on input specifications of incorporated generative models or otherwise predefined specifications. The otherwise predefined specifications may include specifications provided by a user, e.g., a person interacting with the pipeline 300.

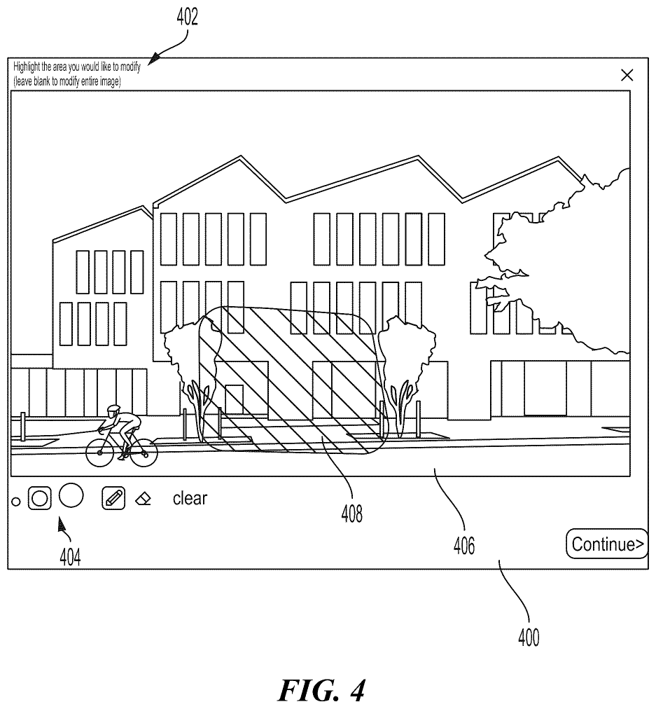

FIG. 4 illustrates an example of an interface 400 for selecting an inpainting region, in accordance with various aspects of the present disclosure. As shown in the example of FIG. 4, the interface 400. The interface 400 may include a prompt 402 directing a user to interact with the interface in some way. The interface 400 may additionally include controls 404, allowing the user to designate portions of media in which to modify. For example, the controls 404 may include highlighter and eraser tools to designate portions of an image. The controls 404 may additionally or alternatively include a timestamp tool (not illustrated) to designate a portion of an audio or video file.

In some examples, the interface 400 may display an image 406. In some examples, a user may designate an indicated region 408 of the image 406 via the controls 404. The indicated region 408 may be implemented by one or more components, such as the pipeline 300 discussed with respect to FIG. 3.

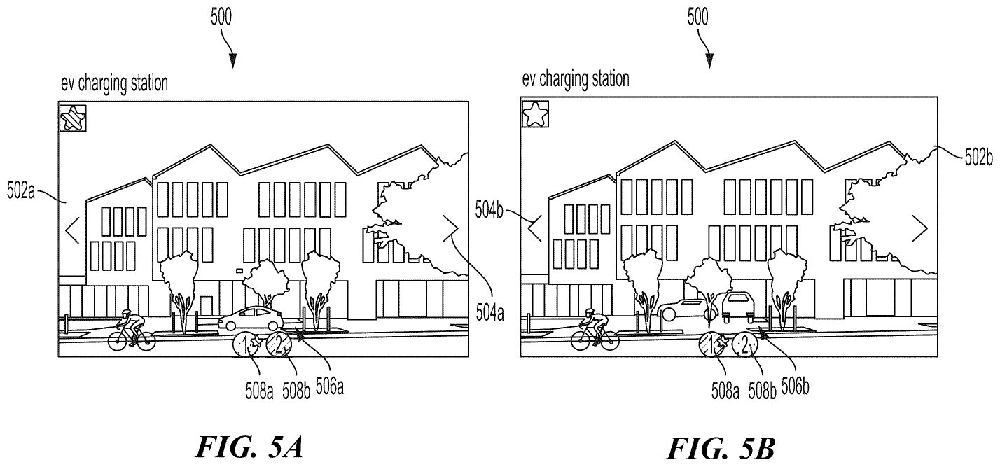

FIG. 5A and FIG. 5B illustrate an interface 500 for an inpainting and rating tool, in accordance with aspects of the present disclosure. In some examples, the interface 500 may be the same interface 400 illustrated with respect to FIG. 4. In the examples of FIGS. 5A and 5B, the interface 500 may display one or more images. FIG. 5A illustrates a first image 502a. FIG. 5B illustrates a second image 502b. A user may alternate between the first image 502a and the second image 502b using a first arrow 504a or a second arrow 504b.

The first image 502a may include a first inpainted region 506a. The second image 502b may include a second inpainted region 506b. In some examples, both inpainted regions 506a and 506b may be based on the indicated region 408 illustrated with respect to FIG. 4. For example, a user may provide an image 406 and an indicated region 408 via the interface 400 illustrated with respect to FIG. 4. The pipeline 300 illustrated with respect to FIG. 3 may receive the image 406, indicated region 408, and a prompt provided by the user. For example, the user may prompt the pipeline 300 to “show an electric vehicle charging station.”

The pipeline 300 may then implement one or more techniques described with respect to FIG. 3 to output the first image 502a and second image 502b, described with respect to FIGS. 5A and 5B based on an image, indicated region, and/or prompt. The image may be an example of the image 406 described with reference to FIG. 4. The indicated region may be an example of the indicated region 408 described with reference to FIG. 4. After the pipeline 300 performs various techniques to manipulate the first image 502a and the second image 502b, the interface 500 may then display the first image 502a and second image 502b to a user. The user may toggle the first selection tool 508a to indicate that the user prefers the first image 502a, or the second selection tool 508b to indicate that the user prefers the second image 502b. Memory associated with the interface 500 may then store the user's selection.

Although the example provided with respect to FIG. 5A and FIG. 5B illustrates a particular implementation, other implementations are contemplated. For example, the interface 500 may implement a slider component to enable the user to provide a rating regarding the first image 502a or second image 502b. The slider component may enable the user to rate media according to a metric, such as perceived quality. In this example, the user may use the first selection tool 508a and second selection tool 508b to provide an absolute rating. The user may additionally or alternatively use the slider component as a forced choice tool to vote or provide a ranking regarding the first image 502a or the second image 502b.

For designers who are incorporating new generative model into an application, it may be difficult to select the correct model. In some examples, the ranking (e.g., rating) may be used to evaluate the outputs from various models. In some such examples, a model associated with the highest ranked output may be implemented into a specific application. In some examples, a straightforward voting-based forced choice tool is specified, where one or more users select a top output. However, this other rating systems are contemplated, such as ranking- or slider-based interactions.

The interface 500 may include one or more components other than the first arrow 504a and second arrow 504b to enable a user to view or listen to output generated by one or more generative models of the pipeline 300, such as a scroll bar. The interface 500, as well as various components of the pipeline 300 and interface 400, may provide a tool allowing a user to configure one or more components of the pipeline 300, interface 400, and/or interface 500. Additionally, the interface 500 may display original input via the interface, such as the input 302. In some examples, the interface 500 may display an audio playback, video playback, or a three-dimensional viewing interface, enabling a user to listen to or view forms of media other than images.

FIG. 6 is a flow diagram illustrating an example process 700 of adapting an input and/or an output for a set of generative models, in accordance with some aspects of the present disclosure. The process 700 may be performed by an input modification module 260 described with reference to FIG. 2. As shown in FIG. 6, the process 600 begins at block 602 by receiving an input for generating a group of outputs via a group of generative models. The input may include a text prompt, an image, and a region indication.

At block 604, the process 600 modifies the input for each generative model of the group of generative models, the input being modified based on a respective specification of each generative model of the group of generative models. Modifying the input may comprise anonymizing the input, resizing the input, padding the input, masking the input, and/or expanding the input. At block 606, the process 600 generates, via each generative model of the group of generative models, the group of outputs based on modifying the input, each generative model generating a respective output of the group of outputs. A group of users may then provide a rating for each output of the group of outputs.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine-readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for modifying an input for a group of generative models, comprising:
receiving the input for generating a group of outputs via the group of generative models;
modifying the input for each generative model of the group of generative models, the input being modified based on a respective specification of each generative model of the group of generative models; and
generating, via each generative model of the group of generative models, the group of outputs based on modifying the input, each generative model generating a respective output of the group of outputs.

2. The method of claim 1, wherein the input includes a text prompt, an image, and a region indication.

3. The method of claim 1, wherein modifying the input comprises anonymizing the input, resizing the input, padding the input, masking the input, and/or expanding the input.

4. The method of claim 1, further comprising:
receiving one or more respective ratings for each output of the group of outputs; and
selecting one generative model of the group of generative models based on receiving the one or more respective ratings.

5. The method of claim 1, further comprising injecting a three-dimensional model into a two-dimensional scene, wherein the three-dimensional model is one output of the group of outputs.

6. The method of claim 1, further comprising:
generating an upscaled image based on a first output of the group of outputs; and
generating a cropped image based on a second output of the group of outputs.

7. The method of claim 1, further comprising determining the respective specification of each generative model of the group of generative models prior to modifying the input.

8. An apparatus for modifying an input for a group of generative models, comprising:
one or more processors; and
one or more memories coupled with the one or more processors and storing instructions operable, when executed by the one or more processors, to cause the apparatus to:
receive the input for generating a group of outputs via the group of generative models;
modify the input for each generative model of the group of generative models, the input being modified based on a respective specification of each generative model of the group of generative models; and
generate, via each generative model of the group of generative models, the group of outputs based on modifying the input, each generative model generating a respective output of the group of outputs.

9. The apparatus of claim 8, wherein the input includes a text prompt, an image, and a region indication.

10. The apparatus of claim 8, wherein execution of the instructions further cause the apparatus to modify the input by anonymizing the input, resizing the input, padding the input, masking the input, and/or expanding the input.

11. The apparatus of claim 8, wherein execution of the instructions further cause the apparatus to:
receive one or more respective ratings for each output of the group of outputs; and
select one generative model of the group of generative models based on receiving the one or more respective ratings receive a rating based on one or more outputs of the group of outputs.

12. The apparatus of claim 8, wherein execution of the instructions further cause the apparatus to inject a three-dimensional model into a two-dimensional scene, the three-dimensional model being one output of the group of outputs.

13. The apparatus of claim 8, wherein execution of the instructions further cause the apparatus to:
generate an upscaled image based on a first output of the group of outputs; and
generate a cropped image based on a second output of the group of outputs.

14. The apparatus of claim 8, wherein execution of the instructions further cause the apparatus to determine the respective specification of each generative model of the group of generative models prior to modifying the input.

15. A non-transitory computer-readable medium having program code recorded thereon for modifying an input for a group of generative models, the program code executed by a processor and comprising:
program code to receive the input for generating a group of outputs via the group of generative models;
program code to modify the input for each generative model of the group of generative models, the input being modified based on a respective specification of each generative model of the group of generative models; and
program code to generate, via each generative model of the group of generative models, the group of outputs based on modifying the input, each generative model generating a respective output of the group of outputs.

16. The non-transitory computer-readable medium of claim 15, wherein the input includes a text prompt, an image, and a region indication.

17. The non-transitory computer-readable medium of claim 15, wherein the program code to modify the input further comprises program code to anonymize the input, resize the input, pad the input, mask the input, and/or expand the input.

18. The non-transitory computer-readable medium of claim 15, wherein the program code further comprises:
program code to receiving one or more respective ratings for each output of the group of outputs; and
program code to select one generative model of the group of generative models based on receiving the one or more respective ratings.

19. The non-transitory computer-readable medium of claim 15, wherein the program code further comprises program code to inject a three-dimensional model into a two-dimensional scene, the three-dimensional model being one output of the group of outputs.

20. The non-transitory computer-readable medium of claim 15, wherein the program code further comprises program code to:
generate an upscaled image based on a first output of the group of outputs;
generate a cropped image based on a second output of the group of outputs; and
determine the respective specification of each generative model of the group of generative models prior to modifying the input.
